(19) United States
(12) Patent Application Publication
(10) Pub. No.: US 2019/0106846 A1
(43) Pub. Date: Apr. 11, 2019

(54) COMPACTION BOUNDARY MAP FOR USE IN PAVING SYSTEMS

(71) Applicant: Caterpillar Paving Products Inc., Brooklyn Park, MN (US)

(72) Inventors: John L. MARSOLEK, Watertown, MN (US); Jacob J. McALPINE, Otsego, MN (US)

(73) Assignee: Caterpillar Paving Products Inc., Brooklyn Park, MN (US)

(21) Appl. No.: 15/727,214

(22) Filed: Oct. 6, 2017

(51) Int. Cl. E01C 19/00; E01C 23/07; G08G 1/0967

(52) U.S. Cl. CPC E01C 19/004; E01C 23/07; G05D 2201/0202; E01C 2201/08; G08G 1/096708

(57) ABSTRACT

A paving method may include acquiring temperature data corresponding to paving material distributed over a work area; developing a compaction boundary map based on the acquired temperature data; and steering a compactor machine based at least in part on the compaction boundary map.

### TECHNICAL FIELD

Examples of the present disclosure relate generally to systems and methods for using temperature data to develop compaction boundary maps. In some examples, operator-controlled or automatic movement of a compactor machine may be based at least in part on the developed compaction boundary map.

### BACKGROUND

Paving systems may include a variety of machines, including a milling machine to remove portions of old pavement, a paving machine to distribute a paving material (e.g., asphalt) over the work area, and a compactor machine to compact the paving material. The paving machine may gather temperature data of a formed material mat.

One use of temperature data gathered by a paving machine is disclosed in U.S. Pat. No. 6,749,364, issued Jun. 15, 2004. The '364 patent discloses using temperature information of a formed material mat correlated with sensed paver position information. The'364 patent discloses displaying the temperature profile of the formed material mat to be compacted. The operator of the compactor can then adjust one or more operational parameters of the compactor, such as the frequency of the compaction vibrator or the travel speed of the compactor.

While the system described by the '364 patent provides for some uses of the temperature data gathered by a paving machine, other uses may be desirable to improve paving operations.

### SUMMARY

Examples of the present disclosure relate to, among other things, developing a compaction boundary map and moving a compactor machine based at least in part on the compaction boundary map. Each of the examples disclosed herein may include one or more of the features described in connection with any of the other disclosed examples.

In one aspect, a paving method includes acquiring temperature data corresponding to paving material distributed over a work area and developing a compaction boundary map based on the acquired temperature data. The method further includes steering a compactor machine based at least in part on the compaction boundary map.

In another aspect, a paving method includes, using at least one temperature sensor mounted to a paving machine, acquiring temperature data corresponding to paving material distributed over a work area and developing a compaction boundary map based on the acquired temperature data, wherein the compaction boundary map includes an area to be avoided by a compactor machine. The method further includes automatically steering and automatically propelling the compactor machine based at least in part on the compaction boundary map.

In yet another aspect, a paving system includes a paving machine including: a temperature sensor configured to acquire temperature data corresponding to paving material distributed over a work area, and a receiver configured to receive position data, and a compactor machine. The system further includes a a control system configured to: develop a compaction boundary map based on the acquired temperature data and position data; and automatically steer a compactor machine based at least in part on the compaction boundary map.

It may be understood that both the foregoing general description and the following detailed description are exemplary and explanatory only and are not restrictive of the invention, as claimed. As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.”

### BRIEF DESCRIPTION OF THE DRAWINGS

The accompanying drawings, which are incorporated in and constitute a part of this specification, illustrate exemplary examples of the present disclosure and together with the description, serve to explain the principles of the disclosure.

FIG. 1 illustrates a system that includes a paving machine and a compactor machine, according to an exemplary embodiment.

FIG. 2 illustrates a compaction boundary map, according to an exemplary embodiment.

FIG. 3 is a flow chart illustrating an exemplary method of steering a compactor machine based at least in part on the compaction boundary map, according to an exemplary embodiment.

### DETAILED DESCRIPTION

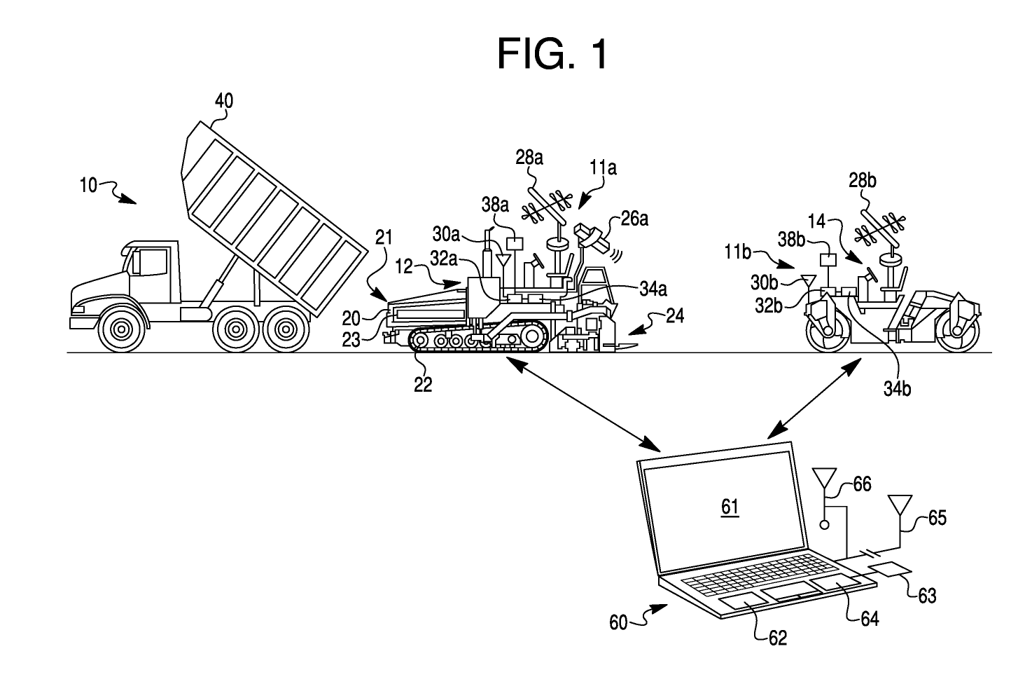

FIG. 1 illustrates an exemplary paving system 10. Paving system 10 may include one or more machines, for example a plurality of different machines, or even a plurality of identical machines in certain embodiments. Each of the machines of paving system 10 is configured to interact with a paving material, typically performing a particular type of work thereon. In one example, paving system 10 includes a paving machine 12 and a compactor machine 14. One or more supply machines 40 may be provided to supply paving material for paving a work surface to the other machines of system 10. While only certain machines are shown, it should be appreciated that for relatively large paving jobs, additional paving machines, additional compactors, supply machines, etc. may be part of system 10.

While in some embodiments system 10 may be used in paving one particular work area, such as a stretch of road, a parking lot, etc., in other embodiments, additional machines at other work areas may be part of a large integrated paving system that includes the machines of system 10 shown in FIG. 1. For example, two or more “paving trains” each having a plurality of machines, located on different sections of a road might all fairly be considered part of one paving system as contemplated herein. In still other embodiments, the control and data logging aspects of the present disclosure may be embodied in a paving system having only a single machine.

Paving machine 12 may include a frame 20 having a set of ground engaging wheels or tracks 22 mounted thereto, as well as a screed 24 for working paving material in a conventional manner. Paving machine 12 may further include a hopper 21 for storing paving material supplied via supply machine 40 or another supply machine and a conveyor system 23 which transfers paving material from hopper 21 to screed 24. Paving machine 12 may further include a receiver 28a mounted to frame 20 which can receive electronic signals comprising position data for machine 12. Position data received via receiver 28a may include geographic position data such as global positioning system (GPS) signals or local positioning signals, or position data indicative of a position of machine 12 relative to other machines of system 10. Alert commands, navigation commands such as start commands, stop commands, machine speed commands, conveyor speed commands, travel direction commands, etc., may also be received via receiver 28a, as well as data signals from other machines of system 10, including paving material temperature data and machine position data as described herein. Paving machine 12 may further include a signaling device such as a transmitter 30a for outputting control signals to other machines, or outputting data signals, mounted to frame 20. In one example, paving machine 12 may transmit a compaction boundary map or data related to or used to generate a boundary map, as described below, to compactor machine 14. A display device 38a, such as an LCD display device, may be mounted to frame 20 for viewing by an operator. In one example, display device 38a may be configured to display a map of a work area, including icons, etc. representing one or more of the machines of system 10.

A computer readable medium or memory 34a, such as RAM, ROM, flash memory, a hard drive, etc., may also be mounted to frame 20. In one embodiment, computer readable memory 34a may have program instructions comprising computer executable code recorded thereon for carrying out one or more of the control functions of the present disclosure, further described herein. Computer readable memory 34a may also be configured to have electronic data associated with operation of system 10 recorded thereon via a memory writing device, including temperature data for paving material with which system 10 interacts, position data, time data, and lift number data, for example. In one embodiment, computer readable memory 34a may have temperature data from a temperature sensor 26a, mounted for example on the body of paving machine 12, recorded thereon during operation, as well as position data received via receiver 28a. Sensor 26a may comprise an optical temperature sensor such as an infrared camera (i.e., thermal camera) or a non-optical sensor such as a digital or analog thermometer.

While sensor 26a is shown mounted on the body of paving machine 12 such that it can scan paving material temperature deposited on a work surface located behind screed 24 as paving progresses, the present disclosure is not thereby limited. In other examples, sensor 26a might be mounted at a different location on machine 12, such as on the screed 24, or be positioned to sense paving material temperature within paving machine 12. A paving control system 11a, of which computer readable memory 34a may be a part, may also be provided, which includes an electronic control unit 32a coupled via wired or wireless connections with each of receiver 28a, transmitter 30a, display device 38a, memory 34a, and sensor 26a. Electronic control unit 32a may comprise a control module which includes the memory writing device mentioned above.

Compactor machine 14 may follow behind paving machine 12, such that it can compact paving material distributed by paving machine 12 while the paving material is still relatively hot. Compactor machine 14 may include similar components as paving machine 12, including a control system 11b. Each of the components of compactor machine 14 may perform the same functions as described in connection with paving machine 12. For example, control system 11b, which includes an electronic control unit 32b and a memory 34b, may store information gathered by various components of system 10 (e.g., sensors, receivers) and execute any of the computing functions and processes described herein.

A display 38b may be used to display maps, guidance, or other information to an operator of compactor machine 14. Compactor machine 14 may further include a receiver 28b which can receive position signals and/or control commands such as machine navigation signals, similar to paving machine 12. A transmitter 30b may also be mounted on machine 14 to transmit position data indicative of a relative or geographic position of machine 14. The components of compactor machine 14 may have similar connections (wired or wireless) to each other as described in connection with the components of paving machine 12. For example, electronic control unit 32b may be coupled with each of receiver 28b, transmitter 30b, display device 38b, and memory 34b. In addition, the components of compactor machine 14 may be in communication (e.g., via WiFi or other wireless communications) with the components of paving machine 12 or a separate control station, such as a control station 60 (described further below). In some embodiments, compactor machine 14 may include a vibratory apparatus, as will be familiar to those skilled in the paving arts.

Control, monitoring, data recording, and data processing relating to system 10 may take place from a variety of locations, either onboard one of machines 12, 14, 40, at a separate command center, or at a combination of sites. It is contemplated that for at least certain paving jobs, system 10 may be used with one or more control stations separate from each of the respective machines. Control station 60 may be a part of system 10 and may comprise a computer station monitored by a paving foreman, technician, etc. Control station 60 may receive signals from any or all of the machines of paving system 10, and may be configured to output control commands to any or all of the machines of paving system 10.

As discussed above, control system 11 may include an electronic control unit 32a for processing electronic data generated during operation of system 10, and outputting appropriate control commands to vary machine operation, as well as storing electronic data. Control station 60 may serve as an alternative or supplemental command center to process data and output control comments, and may additionally or alternatively provide a location where personnel can monitor paving progress, view maps of the work area, etc. To this end, control station 60 may also include a receiver 66, an electronic control unit 62, a memory 64, and a transmitter 65. Electronic control unit 62 might also comprise a memory writing device 63 configured to record electronic data from any of machines 12, 14, or 40 on memory 64. It should be appreciated that any or all of the control and data recording aspects of system 10 might take place at control station 60, via a laptop computer, a PDA, cell phone, etc. Furthermore, any of the components of control system 11, illustrated on paving machine 12, might be located at least in part at another machine (e.g., compactor machine 14) or at control station 60.

### INDUSTRIAL APPLICABILITY

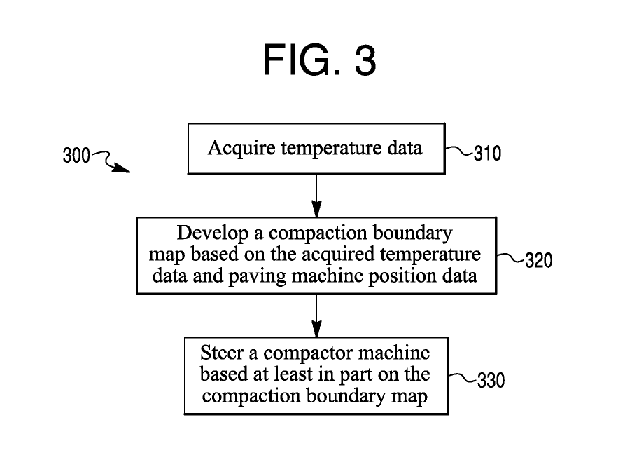

Referring to the method 300 of FIG. 3, during use of paving system 10, paving machine 12 may acquire temperature data corresponding to paving material distributed over a work area (step 310). As described above, sensor 26a may scan the paving material (e.g., asphalt) located behind paving machine 12 as paving progresses. In one example, sensor 26a may include a thermal camera. In some examples, a plurality of temperature sensors 26a, either mounted on paving machine 12 or on multiple paving machines, may be used to acquire temperature data.

It may be desirable in some instances to capture thermal images of an entire work surface by scanning numerous areas of paving material with which a machine has interacted or is about to interact, then associating each of the locations with position data. For example, a thermal camera or the like, or multiple point sensors, could initially produce data corresponding to the two-dimensional surface of the work area. Next, each data point, for example, each pixel of a thermal image, could be associated with a positioning system, such as GPS. A computer, such as one or more of control systems 11a, 11b, or 60, could then store temperature data with the corresponding position data for the entire area. Because the GPS data may have been received by paving machine 12 during distribution of the paving material, the GPS data may be associated with the path of paving machine 12. The temperature and position data could also be associated with time data, such that each sensed area could have a temperature coordinate, a position coordinate, and a time coordinate. Where multiple lifts of paving material are used, a lift number coordinate could also be used.

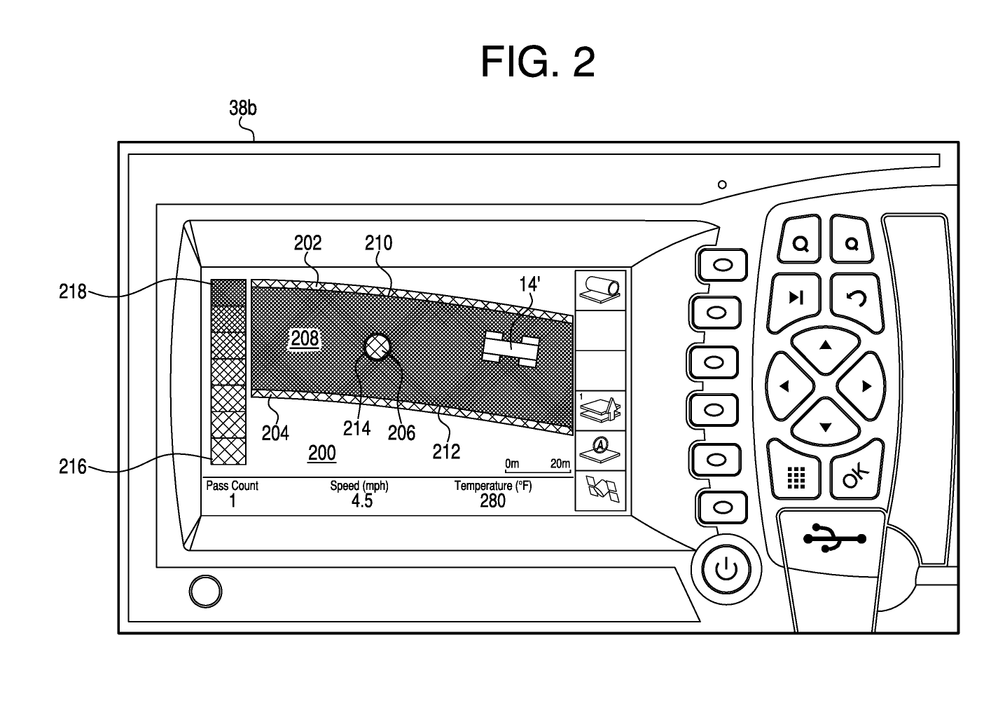

Referring to step 320 of FIG. 3, the temperature data, and any corresponding GPS, time, and/or lift data, may be processed by one or more of control systems 11a, 11b, 60 (referred to generally as a control system) to develop a compaction boundary map 200, as shown in FIG. 2. As used herein, a compaction boundary map designates separations or boundaries between: 1) one or more areas in which compaction is desired, and 2) one or more areas in which compaction is to be avoided. When visible, a compaction boundary map may use straight, curved, or irregular lines to designate the boundaries. However, boundaries of a compaction map do not need to be shown on a display, as long as data corresponding to the boundaries (e.g., position coordinates) can be accessed by an operator or one or more control systems. Compaction boundary map 200 may correspond to a single pass of paving machine 12 or to a plurality of passes of one or more paving machines.

During temperature data processing, algorithms stored in the memory of any of the control systems/stations described herein may be executed to evaluate temperature differences between areas of distributed paving material. For example, referring to FIG. 2, a first area 202, a second area 204, and a third area 206 may each have a temperature that is cooler than a temperature of a fourth area 208. The algorithms of the control system may determine boundaries between various areas having different temperatures. In the example of FIG. 2, compaction boundary map 200 may include a first boundary 210 separating first area 202 and fourth area 208, a second boundary 212 separating second area 204 and fourth area 208, and a third boundary 214 separating fourth area 208 and third area 206.

The boundaries of compaction map 200 may be developed based on the temperature data, including differences in temperature between areas of distributed paving material. For example, a boundary may be placed to separate an area in which the temperature is below (or at) a predefined threshold from an area in which the temperature is above (or at) the predefined threshold. The predefined threshold may be between 280 and 300 degrees Fahrenheit, and in some examples may be 240 to 280 degrees Fahreheit. In another example, a boundary may be placed where the temperature begins decreasing or increasing at a certain rate along the paving material, with such rate being dependent upon, for example, ambient temperature, paving thickness, humidity, and/or sun exposure.

First boundary 210 and second boundary 212 may serve as exterior boundaries for compactor machine 14. In other words, compaction may be desired within area 208 between first and second boundaries 210, 212. First and second areas 202 and 204 may be areas to be avoided by compactor machine 14. In some examples, within exterior first and second boundaries 210, 212, compaction map 200 may designate an additional boundary (e.g., third boundary 214), around another area to be avoided by compactor machine 14.

In certain examples, areas that correspond to paving material having cooler temperatures (e.g., when measured by sensor 26a of paving machine 12) may be areas to be avoided by compactor machine 14. As shown in FIG. 2, first, second, and third areas 202, 204, and 206 are shown having temperatures near a cooler end 216 of a temperature scale, and fourth area 208, where compaction may be desired, may have a temperature near a hotter end 218 of the temperature scale.

In the example of FIG. 2, first and second areas 202 and 204 may represent curbs which paving material has been distributed between. Since compactor machine 14 may damage curbs, it may be desirable for compactor machine 14 to avoid the curbs represented by first and second areas 202, 204. Third area 206 may represent a sewer object over which paving material has been distributed. A sewer object may be a manhole, grate, drainage pipe or open channel, or any other object that is part of a sewer or drainage system. Since compactor machine 14 may damage sewer objects, third area 206 also may be an area to be avoided by compactor machine 14. The compaction boundary map 200 may also be used to locate the paving machine 12 after the paving machine 12 has laid the asphalt.

Referring to step 330 of FIG. 3, compactor machine 14 may be steered based at least in part on compaction boundary map 200. In some examples, an operator on paving machine 14 or at control station 61 may control movement of compactor machine 14 based at least in part on compaction boundary map 200. Compaction boundary map 200 may be displayed on display 38b of compactor machine 14 or on a display 61 of control station 60 for viewing by an operator. Using the boundaries as a guide, the operator may steer, propel, or otherwise control movement of compactor machine 14 to compact fourth area 208. As used herein, “steer” may include turning compaction machine 14 left or right, and “propel” may include changing the speed of compactor machine 14, whether to increase or decrease the speed. Compaction boundary map 200 may include an icon 14′ or other graphic representing the current location of compactor machine 14 to aid the operator in steering or propelling. The operator may steer or propel compactor machine 14 either from a position on compactor machine 14 or from a remote location to compact fourth area 208. The control system may provide an alert or other signal to the operator as the operator approaches any of the areas to be avoided (e.g., first, second, and third areas 202, 204, 206).

In another example, compaction boundary map 200 is not visually displayed to an operator. Instead, the information contained in compaction boundary map 200 may be stored in memory 34a, 34b, or 64 of the control systems described herein, and certain data may be accessed by an operator or control system. For example, an operator may access position coordinates corresponding to compaction boundaries 210, 212, 214 and may use or rely on these coordinates to steer, propel, or otherwise control movement of compactor machine 14 to compact fourth area 208.

In another example, the control system may automatically control movement of compactor machine 14 based at least in part on compaction boundary map 200. As described above, the control system may access the data of compaction boundary map 200, and does not need a visual display. “Automatic,” as used herein, means without input or direction by a person. In other words, the control system may steer compactor machine 14 (e.g., change the direction of movement) or propel compactor machine 14 (e.g., speed up or slow down movement) based on compaction boundary map 200, without specific input from a person.

The control system may work in conjunction with an operator to automatically control certain movements of compactor machine 14. For example, the operator may drive compactor machine 14 along fourth area 208 in a first direction at a first speed. The control system may be aware of the position of compactor machine 14 based on GPS signals received by receiver 28b, and may be able to compare the position of compactor machine 14 to the position data of compaction boundary map 200. Accordingly, if compactor machine 14 approaches (e.g., comes within a predefined distance) or crosses any of first, second, or third boundaries 210, 212, 214, the control system may automatically cause the steering mechanism of compactor machine 14 to turn left or right, as appropriate, to cause compactor machine 14 to move in a second direction and avoid compacting the first, second, or third areas 202, 204, 206. In another example, or in the event automatic steering would not avoid the first, second, or third areas 202, 204, 206, the control system may automatically slow the speed of compactor machine 14 to a second speed to avoid compacting first, second, or third areas 202, 204, 206. In certain circumstances, the speed of the compactor machine 14 may be slowed by temporarily stopping the motor of compactor machine 14.

In another example, the control system may fully automatically direct movement of compactor machine 14 based on compaction boundary map 200. In other words, the control system may steer and propel compactor machine 14 from a first location to a second location, without input from an operator (other than to start and stop the compacting operation). After the operation has started, the control system may steer and propel compactor machine 14 to compact a predefined work area, using the position data of the compaction boundary map 200 and comparing it to position data of the moving compactor machine 14. In one example, the control system may fully automatically compact fourth area 208, while avoiding first, second, and third areas 202, 204, 206. The control system may fully automatically direct compactor machine 14 for a single pass of compactor machine 14 (e.g., to compact one lane of a road or one strip of another type of paved area) or for multiple passes of compactor machine 14 (e.g., to compact two or more lanes of a road or two or more strips of another type of paved area). Paving system 10 may include standard collision avoidance sensors and systems to prevent compactor machine 14 from colliding with people or objects when it is being automatically controlled.

In contrast to existing uses of temperature data during paving operations, the systems and methods described herein allow temperature data to be used to develop a compaction boundary map for operator-controlled, semi-automatic, or fully automatic control of compactor machine movement. The compaction boundary map may be displayed to an operator or stored in memory for access by the operator or control system. In some examples, a control system, working with an operator or in fully automatic mode, may steer and/or propel compactor machine 14 to compact a desired work area while avoiding certain other areas.

While principles of the present disclosure are described herein with reference to illustrative examples for particular applications, it should be understood that the disclosure is not limited thereto. Those having ordinary skill in the art and access to the teachings provided herein will recognize additional modifications, applications, and substitution of equivalents all fall within the scope of the examples described herein. Accordingly, the invention is not to be considered as limited by the foregoing description.

1. A paving method, comprising:
acquiring temperature data corresponding to paving material distributed over a work area, wherein acquiring temperature data includes scanning, with a sensor mounted on a paving machine, the paving material located behind the paving machine, receiving position data for the paving machine from a location sensor, and associating the acquired temperature data with the position data;
developing a compaction boundary map based on the acquired temperature data, wherein developing the compaction boundary map includes using the acquired temperature data and the associated position data to identify one or more areas to be compacted by a compactor machine and an area to be avoided by the compactor machine; and
steering and propelling the compactor machine based at least in part on the compaction boundary map.

2. The method of claim 1, wherein the developing of the compaction boundary map includes using the acquired temperature data to identify an area to be avoided by the compactor machine by identifying an area that is below a predetermined threshold temperature, and wherein at least a portion of the area to be avoided is within the area to be compacted.

3. The method of claim 2, wherein the area to be avoided includes at least one of a curb or a sewer object, and wherein the area to be avoided by the compactor machine is avoided by the compactor machine for the entirety of the paving method.

4. The method of claim 1, wherein the steering of the compactor machine based at least in part on the compaction boundary map includes automatically steering the compactor machine.

5. The method of claim 1, wherein the propelling of the compactor machine based at least in part on the compaction boundary map includes automatically propelling the compactor machine.

6. The method of claim 1, further including fully automatically steering and propelling the compactor machine based on the compaction boundary map without input from an operator.

7. The method of claim 6, wherein the compactor machine follows behind the paving machine.

8. The method of claim 1, wherein the sensor mounted on the paving machine is a temperature sensor mounted on a rear of the paving machine.

9. The method of claim 8, wherein the compaction boundary map is based on GPS data associated with a path of the paving machine.

10. The method of claim 1, wherein acquiring the temperature data includes obtaining the temperature data from a plurality of temperature sensors.

11. The method of claim 1, wherein the compaction boundary map is provided on a display.

12. A paving method, comprising:
using at least one temperature sensor mounted to a paving machine, acquiring temperature data corresponding to paving material distributed over a work area;
developing a compaction boundary map based on the acquired temperature data and locational data associated with a path of the paving machine, wherein the compaction boundary map includes an area to be compacted by a compactor machine and an area to be avoided by the compactor machine, wherein at least a portion of the area to be avoided is within the area to be compacted; and
automatically steering and automatically propelling the compactor machine based at least in part on the compaction boundary map without input from an operator.

13. The method of claim 12, wherein the area to be avoided by the compactor machine corresponds to temperature data below a predefined threshold.

14. The method of claim 12, wherein the method includes fully automatically steering and fully automatically propelling the compactor machine based at least in part on the compaction boundary map.

15. The method of claim 12, wherein a width of the compaction boundary map corresponds to a single pass of the paving machine.

16. The method of claim 12, wherein a width of the compaction boundary map corresponds to a plurality of passes of one or more paving machines.

17. A paving system, comprising:
a paving machine including: a temperature sensor configured to acquire temperature data corresponding to paving material distributed over a work area, and a receiver configured to receive position data for the paving machine;
a compactor machine; and
a control system configured to:
develop a two-dimensional compaction boundary map based on the acquired temperature data and position data for the paving machine; and
automatically steer the compactor machine over the two-dimensional compaction boundary map based at least in part on the compaction boundary map and without input from an operator.

18. The system of claim 17, wherein the control system is configured to automatically steer the compactor machine when the compactor machine is within a predefined distance of a compaction boundary.

19. The system of claim 17, wherein automatically steering includes comparing a position of the compactor machine from a second receiver configured to receive position data for the compactor machine to position data of the compaction boundary map.

20. The system of claim 17, wherein the control system is further configured to automatically propel the compactor machine without input from an operator.
